(19) United States
(12) Patent Application Publication
(10) Pub. No.: US 2013/0090943 A1
(43) Pub. Date: Apr. 11, 2013

(54) SYSTEM AND METHOD FOR HEALTH CARE PRODUCT SELECTION

(71) Applicants: Prakash Upadhyayula, Plainfield, IL (US); Venkatesh Subramaniam, Glen Allen, VA (US); Suparna Dutta, Charlotte, NC (US); Sanjith Rai, Princeton, NJ (US); Ramesh Eevani, Monmouth Junction, NJ (US)

(72) Inventors: Prakash Upadhyayula, Plainfield, IL (US); Venkatesh Subramaniam, Glen Allen, VA (US); Suparna Dutta, Charlotte, NC (US); Sanjith Rai, Princeton, NJ (US); Ramesh Eevani, Monmouth Junction, NJ (US)

(73) Assignee: WELLPOINT, INC., Chicago, IL (US)

(21) Appl. No.: 13/615,745

(22) Filed: Sep. 14, 2012

Related U.S. Application Data
(60) Provisional application No. 61/535,549, filed on Sep. 16, 2011.

(51) Int. Cl. G06F 19/00

(52) U.S. Cl. CPC G06F 19/328
USPC 705/2

(57) ABSTRACT

Systems, methods and computer-readable media for assisting consumers to enroll in a health plan in an online environment. Data comprising residence information, date of birth information and gender information of a consumer is received. Data comprising a type of health insurance product selected by the consumer is received. Data comprising physician information selected by the consumer is received. Result information is retrieved from one or more databases. The result information includes one or more health insurance plans of the type selected by the consumer, and information describing whether physicians associated with the physician information selected by the consumer are included within a network of each of the health insurance plans. The result information is displayed to the consumer. A request from the consumer to enroll in one of the health insurance plans is received.

### CROSS REFERENCE TO RELATED APPLICATIONS

This application claims priority to U.S. Provisional Patent Application No. 61/535,549, filed Sep. 16, 2011, the entirety of which is incorporated herein by reference.

### FIELD OF THE INVENTION

The systems and methods described herein relate to selecting health care products.

### BACKGROUND

Given the gamut of health care products available in the market, selecting a product is a challenging task for consumers. One of the primary concerns for consumers while selecting a health insurance product is whether their doctors and hospitals are participating (in network or out of network) for the selected product, as well as the extent to which a health insurance product covers a medication taken by the consumer. This criterion is especially important to the Senior Market.

Some health insurer web sites allow customers to search providers to determine the plans in which such providers participate. However, this information is static and not integrated with the quoting or enrollment process. For example, a typical experience of a consumer looking for healthcare insurance, who wants to know if their current provider will be covered by a plan, involves a number of steps. First, the consumer must visit the website of the insurance company and identify all plans that are offered. Then, the consumer must call his provider's office to check which of those plans are accepted by the provider. Then, the consumer must return to the web site, examine the plans to determine which fit the consumer's budget and other criteria. If the plans do not fit the consumer's criteria, another call may need to be made to the provider. Some insurance company websites allow a consumer to search for a provider to obtain a list of all the plans in which the provider participates. However, this feature is also sub-optimal because it is not integrated with the enrollment process. The consumer must manually take note of all the plans in which the provider participates, and have that information available during the enrollment process. This is prone to errors.

All known options are cumbersome and, typically, consumers abandon the on-line process and call customer service. This may result in loss of business to an insurance company, or result in higher costs by having to employ additional personnel to handle telephone-initiated enrollment.

### SUMMARY OF EMBODIMENTS OF THE INVENTION

The present invention is directed to systems, methods and computer-readable media for selecting health plans in which to enroll in an online environment. Data comprising residence information, date of birth information and gender information of a consumer is received. Data comprising a type of health insurance product selected by the consumer is received. Data comprising physician information, facility information and/or medication information selected by the consumer is received. Result information is retrieved from one or more databases. The result information includes one or more health insurance plans of the type selected by the consumer, and information describing whether physicians, facilities and/or medications associated with the physician/facility/medication information selected by the consumer are included within a network of, or covered by, each of the health insurance plans. The result information is displayed to the consumer. A request from the consumer to enroll in one of the insurance plans is received.

### BRIEF DESCRIPTION OF THE DRAWINGS

FIG. 1 is an exemplary system diagram, in accordance with one embodiment of the present invention;

FIGS. 2A, 2B, 2C, 2D, and 2E are exemplary user interfaces that may be rendered in accordance with one embodiment of the present invention;

FIG. 3 is a flow diagram illustrating an exemplary method of one embodiment of the present invention; and

FIG. 4 is a diagram showing exemplary hardware and software that may be used in connection with one embodiment of the present invention.

### DETAILED DESCRIPTION

The systems and methods herein provide a collection of web applications and supporting web services designed to enable consumers search for plans, obtain quotes on selected plans and enroll in an online process (referred to herein generally as the “online store”). The examples described herein relate to the senior populations searching for Medicare plans; however, the invention is not so limited and can be used by any consumer making a health care product selection. As described in more detail herein, the online store makes provider/facility and medication information available to the consumer during the quoting and enrollment process. This makes it easier for the customer to enroll in plans in which their providers/facilities participate, and which cover their medications. In particular, the system employs functionality to provide network information at the product level, which helps consumers narrow down their product selection based on the networks in which the providers/facilities participate. Thus, in one embodiment, as part of the quoting process, the online system allows the consumer to search for doctors using search criteria such as city, state or zip code, doctor last/first name or office name. Once found, consumers can add a provider to their doctors list. Similarly, the consumer can also create a hospitals/facilities list. The consumer can also view the listing of doctors/hospitals/facilities that are in network and out of network. As the consumer continues to navigate to the plan listing page, the consumer is able to choose a plan that supports his needs of providers, pharmacies and current drug list, and subsequently enroll with ease.

In an exemplary embodiment, the functionality described herein is employed in a three-tiered application, as will be known and understood by those skilled in the art. The application user interface is an ASP.NET web application, in the exemplary embodiment. It has no direct database interaction except for that which maintains session state across the application nodes, which is a standard ASP.NET feature. The application relies on the APE service tier (i.e., Application Processing Engine, which is a set of web services instrumental in quoting, rating and enrollment processing) for data persistence. Other configurations will be known to those skilled in the art and are within the scope of the present invention.

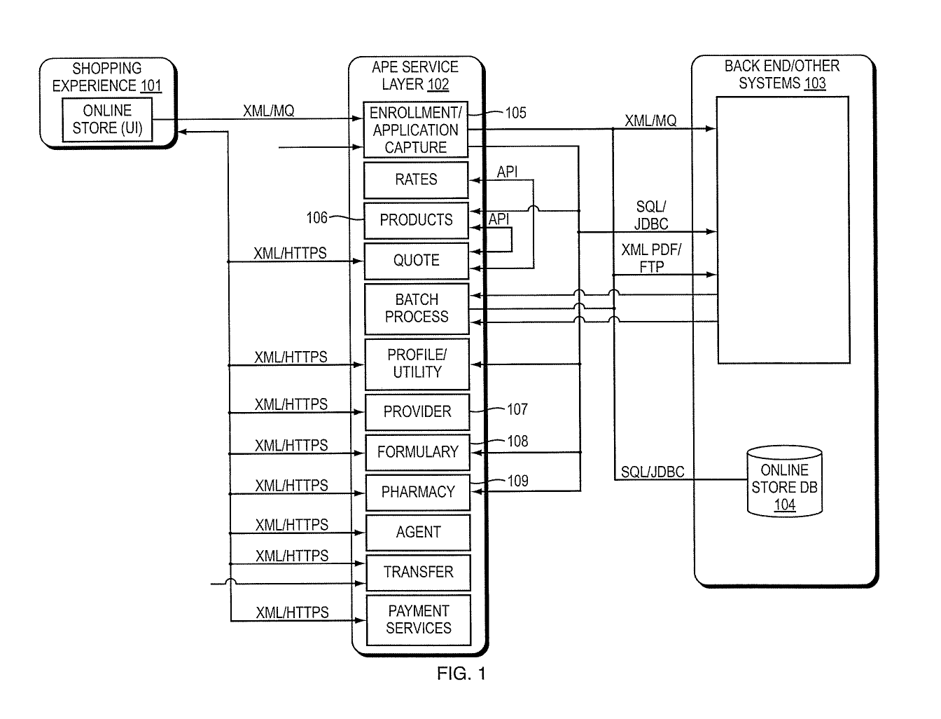

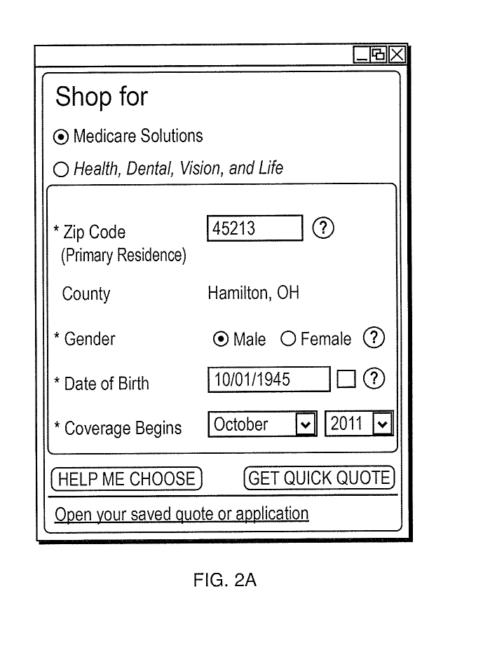

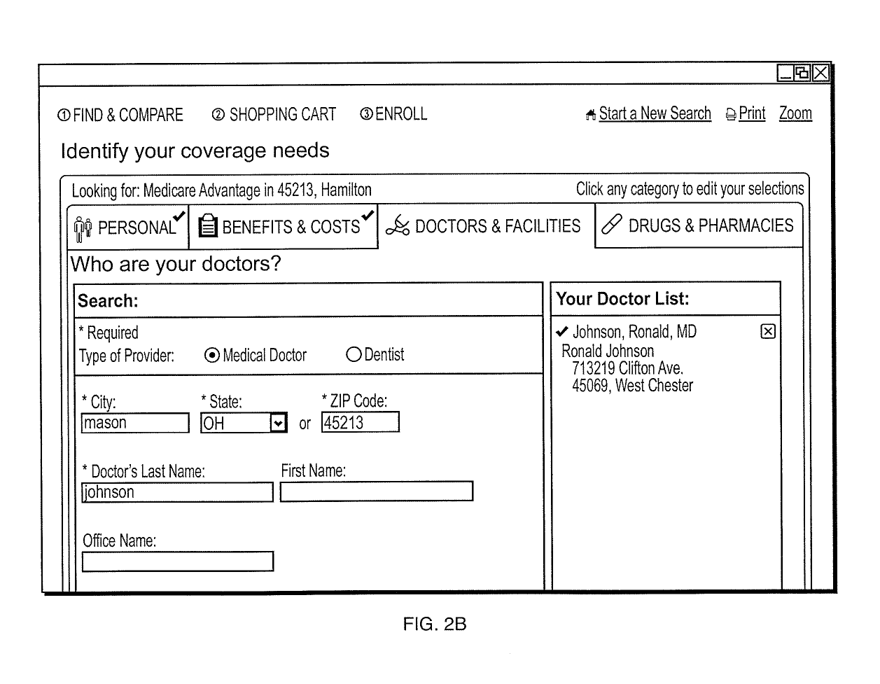

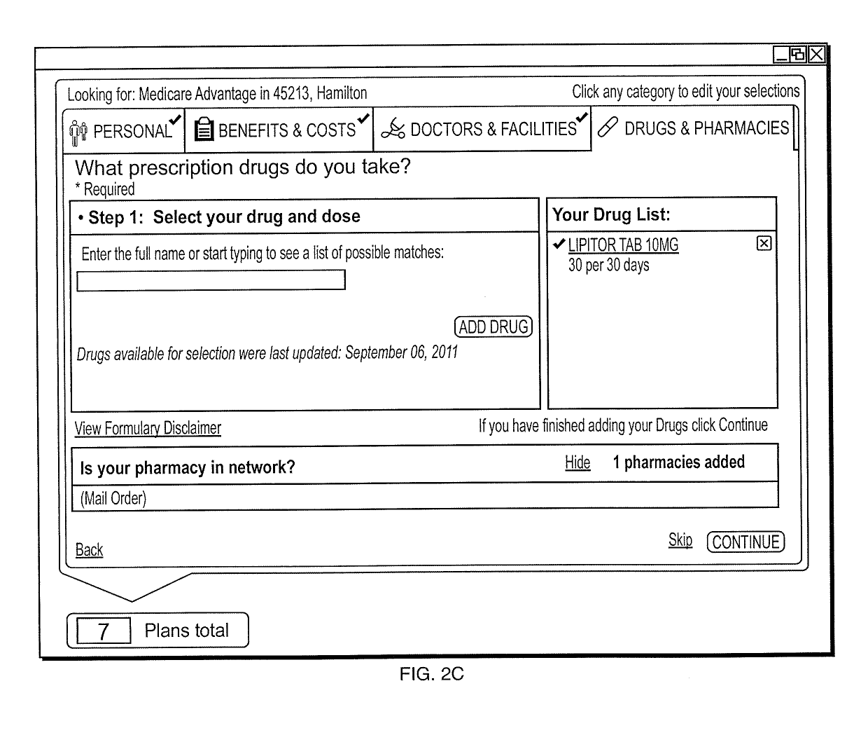

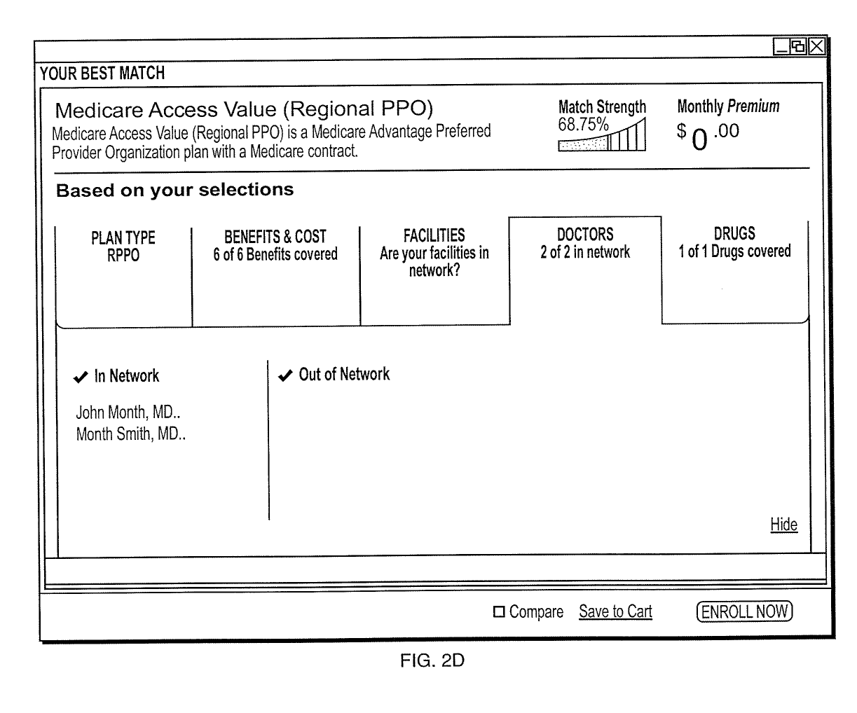

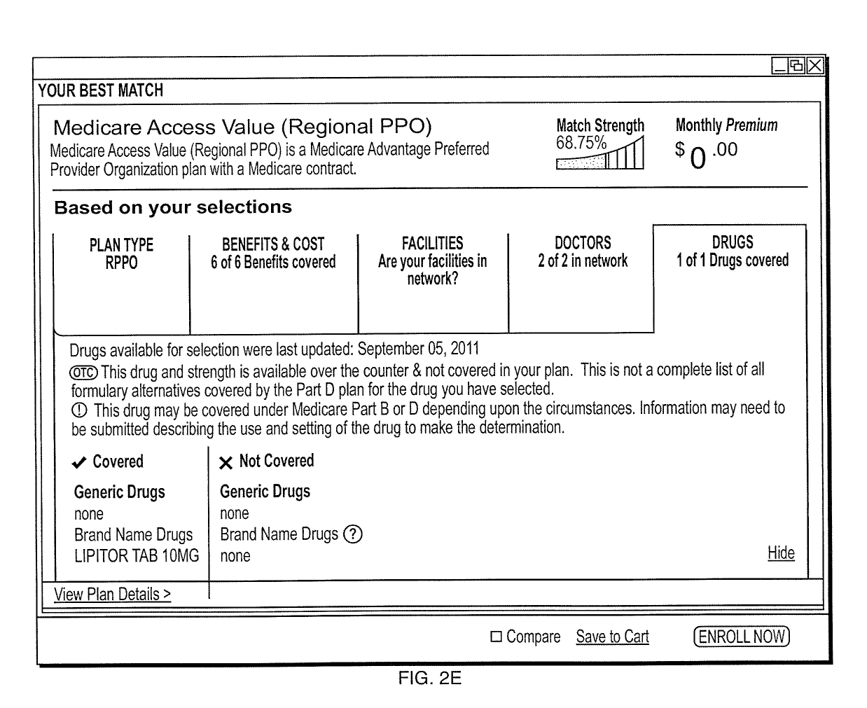

FIG. 1 illustrates an exemplary manner in which the systems involved in implementing the online store functionality are integrated. The online store user interface 101 makes calls to the APE service layer 102 for various information in connection with the plan selection, quoting and enrollment process. Back end systems 103 include the provider directory, and enrollment and billing systems. The provider directory is used to obtain the provider networks and information. The enrollment and billing systems are the final destination of approved applications for insurance which holds the membership information]. Product, Rates, User transaction and In progress Enrollment information are stored on the online store database 104. With reference to FIGS. 2A, 2B, 2C, 2D and 2E, exemplary user interfaces displayed to the consumer as he navigates the online store are shown and described. As shown in FIG. 2A, the consumer may input his zip code, date of birth, gender, product type (e.g., Medicare Solutions or Health, Dental Vision and Life) and click the “Help Me Choose” or “Quick Quote” button. The latter provides a narrower approach focusing on offering the consumer a short range of plans matching their criteria, while the former a diverse full array of plans and plan types available to the consumer in their location. Upon selecting “Help Me Choose”, the user will navigate to the interface shown in FIG. 2B. Using the interface of FIG. 2B, the consumer may input his preferred list of doctors and/or facilities. With reference to FIG. 2C, the consumer may also include drugs and/or pharmacies. The system then performs a search based on the consumer's input criteria and returns the results. As shown in FIG. 2D, the displayed results inform the consumer what plan types are available, what benefits are covered by the plan, the extent to which the consumer's doctors and facilities are in network, and whether the indicated drugs are covered. FIG. 2E shows the screen describing coverage for the indicated drugs. Assuming the results meet with the consumer's approval, the consumer can simply select the “Enroll Now” button to engage the enrollment process.

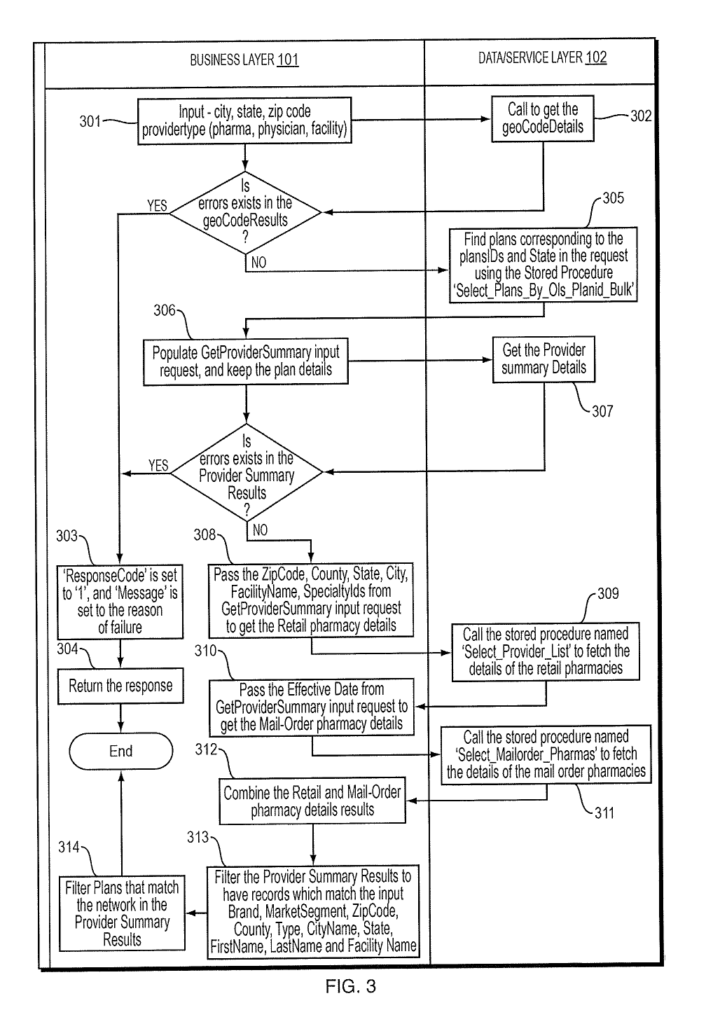

FIG. 3 is a flow diagram illustrating an exemplary process for carrying out one embodiment of the invention. Once the consumer provides all his inputs, as described above with reference to FIGS. 2A through 2E, information reflecting the city, state and zip code of the consumer, as well as the products (see Products 106 of FIG. 1), physicians and/or facilities (see Provider 107 of FIG. 1), pharmacies (see Pharmacy 109 of FIG. 1) and/or medications (see Formulary 108 of FIG. 1) of interest are captured by the business/user interface layer, in step 301. A call is made to the service layer 102, in step 302, to obtain geographic codes (i.e., to obtain the latitude and longitude of the provided address and find the center point for the search radius for physicians/facilities). If there are errors encountered in connection with this request, an error message is generated, in step 303, and displayed to the consumer, in step 304. Otherwise, in step 305, the plan networks corresponding to the plan identifiers and corresponding state in the request are found based on a mapping table of the PlanId/State combination to the respective plan network code. In step 306, the request to obtain details about the provider(s) that are the subject of the consumer's selection is populated in step 306. The plan identifier details obtained in step 305 are retained to reverse map the plan network code to the PlanId. In step 307, details regarding the providers selected by the consumer are obtained. If an error is encountered in obtaining provider details, an error message is generated (step 303), and displayed to the consumer, in step 304. Otherwise, in step 308, the request to obtain retail pharmacy details is passed based on user selection of the location and specialty. In step 309, a stored procedure is called to obtain details of pharmacies based on zip code and specialty passed. In step 310, the effective date for the plans quoted is passed to get the mail order pharmacy details. In step 311, a stored procedure is called to obtain the details of the mail order pharmacies based on the quote effective date chosen by the user. In step 312, the retail and mail order pharmacy detail results obtained are combined. In step 313, the provider summary results are filtered to determine a result set that matches the brand, market segment, zip code of the consumer, county of the consumer, type (e.g., HMO, PPO, etc.), city, state, first and last name of the provider, and any facility name input by the consumer. In step 314, the result set is further filtered to identify the plans that match the network in the provider summary results. The provider summary results will have the list of plans (i.e., by plan identifier) that each provider is in the network, based on processing of steps 305 and 306. The list of plans obtained from the product search for that demographic is iterated through the provider summary to see if the plan identifier is under any of the providers. If there is a match, then that provider is marked in network for the plan; if not, that provider is marked out of network. This filtering is done for each plan in the listing obtained.

Thus, for example, a plan search for a given demographic returns 2 plans Plan A (planId=101) and Plan B (planId=102). When the user searches for providers in a location, the planId is passed with the search. The process of step 305 checks the corresponding network for the plans, e.g., planId 101 is network A and planId 102 is network B. The search for a provider yields 4 providers in the location, Provider 1 participating in network A, Provider 2 participating in network B, Provider 3 participating in network A & network B, and Provider 4 participating in neither of them. The process of step 306 maps them back to the corresponding planId. Thus, the Provider Summary result will have Provider 1−>PlanId 101, Provider 2−>PlanId 102, Provider 3−>PlanId 101, PlanId 102, Provider 4−>NONE. Then, the process of step 314 filters the plan in Plan Search against the Provider Summary result so that Plan A (PlanId 101) will have Provider 1 and Provider 3 as in network and the other providers out of network. Plan B (planId 102) will have Provider 2 and Provider 3 as in network and the rest out of network. These results are then displayed to the consumer, who may proceed to enroll, as indicated above (see enrollment/application capture 105 of FIG. 1).

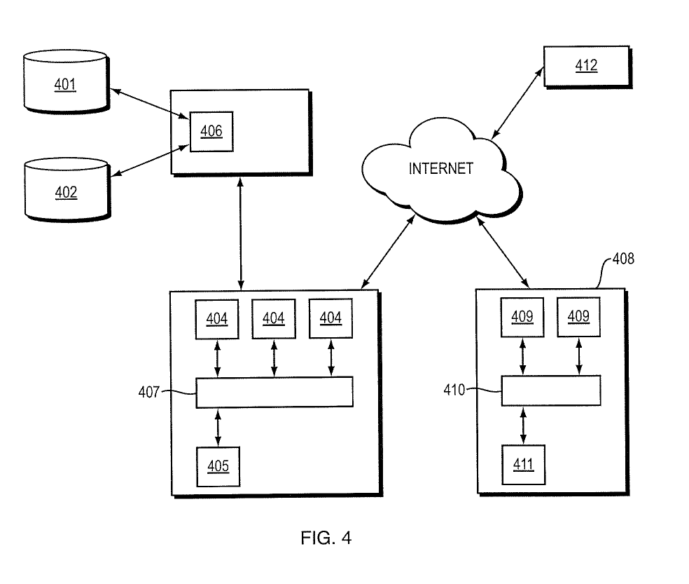

The systems described herein comprise a number of different hardware and software components. Exemplary hardware and software that can be employed in connection with that system are now generally described with reference to FIG. 4. Database server(s) 400 may include a database services management application 406 that manages storage and retrieval of data from the database(s) 401, 402 (such as, e.g., online store database 104). The databases may be relational databases; however, other data organizational structure may be used without departing from the scope of the present invention. One or more application server(s) 403 are in communication with the database server 400. The application server 403 communicates requests for data to the database server 400. The database server 400 retrieves the requested data. The application server 403 may also send data to the database server for storage in the database(s) 401, 402. The application server 403 comprises one or more processors 404, computer readable storage media 405 that store programs (computer readable instructions) for execution by the processor(s), and an interface 407 between the processor(s) 404 and computer readable storage media 405. The application server may store the computer programs referred to herein.

To the extent data and information is communicated over the Internet (e.g., by a consumer employing the online store user interface 101 to access services layer 102), one or more Internet servers 408 may be employed. The Internet server 408 also comprises one or more processors 409, computer readable storage media 411 that store programs (computer readable instructions) for execution by the processor(s) 409, and an interface 410 between the processor(s) 409 and computer readable storage media 411. The Internet server 408 is employed to deliver content that can be accessed through the communications network. When data is requested through an application, such as an Internet browser, the Internet server 408 receives and processes the request. The Internet server 408 sends the data or application requested along with user interface instructions for displaying a user interface.

The computers referenced herein are specially programmed, in accordance with the described algorithms, to perform the functionality described herein.

The non-transitory computer readable storage media that store the programs (i.e., software modules comprising computer readable instructions) may include volatile and non-volatile, removable and non-removable media implemented in any method or technology for storage of information such as computer-readable instructions, data structures, program modules, or other data. Computer readable storage media may include, but is not limited to, RAM, ROM, Erasable Programmable ROM (EPROM), Electrically Erasable Programmable ROM (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computer system and processed using a processor.

What is claimed is:

1. A computer implemented method comprising:
receiving data comprising residence information, date of birth information and gender information of a consumer;
receiving data comprising a type of health insurance product selected by the consumer;
receiving data comprising physician information selected by the consumer;
retrieving from one or more databases result information, the result information comprising one or more health insurance plans of the type selected by the consumer, and information describing whether physicians associated with the physician information selected by the consumer are included within a network of each of the health insurance plans;
displaying the result information to the consumer; and
receiving a request from the consumer to enroll in one of the health insurance plans.

2. The computer implemented method of claim 1 further comprising:
receiving data comprising medication information selected by the consumer;
wherein the result information further comprises information describing whether medication associated with the medication information selected by the consumer is covered by each of the health insurance plans.

3. The computer implemented method of claim 1 further comprising:
receiving data comprising health facility information selected by the consumer;
wherein the result information further comprises information describing whether health facilities associated with the health facility information selected by the consumer are included within the network of each of the health insurance plans.

4. A non-transitory computer-readable storage medium that stores instructions which, when executed by one or more processors, cause the one or more processors to perform a method comprising:
receiving data comprising residence information, date of birth information and gender information of a consumer;
receiving data comprising a type of health insurance product selected by the consumer;
receiving data comprising physician information selected by the consumer;
retrieving from one or more databases result information, the result information comprising one or more health insurance plans of the type selected by the consumer, and information describing whether physicians associated with the physician information selected by the consumer are included within a network of each of the health insurance plans;
displaying the result information to the consumer; and
receiving a request from the consumer to enroll in one of the health insurance plans.

5. The non-transitory computer-readable storage medium of claim 4, wherein the method performed by the processor further includes:
receiving data comprising medication information selected by the consumer;
wherein the result information further comprises information describing whether medication associated with the medication information selected by the consumer is covered by each of the health insurance plans.

6. The non-transitory computer-readable storage medium of claim 4, wherein the method performed by the processor further includes:
receiving data comprising health facility information selected by the consumer;
wherein the result information further comprises information describing whether health facilities associated with the health facility information selected by the consumer are included within the network of each of the health insurance plans.

7. A system comprising:
memory operable to store at least one program; and
at least one processor communicatively coupled to the memory, in which the at least one program, when executed by the at least one processor, causes the at least one processor to:
receive data comprising residence information, date of birth information and gender information of a consumer;
receive data comprising a type of health insurance product selected by the consumer;
receive data comprising physician information selected by the consumer;
retrieve from one or more databases result information, the result information comprising one or more health insurance plans of the type selected by the consumer, and information describing whether physicians associated with the physician information selected by the consumer are included within a network of each of the health insurance plans;
display the result information to the consumer; and
receive a request from the consumer to enroll in one of the health insurance plans.

8. The system of claim 7, wherein the processor is further caused to:
receive data comprising medication information selected by the consumer;
wherein the result information further comprises information describing whether medication associated with the medication information selected by the consumer is covered by each of the health insurance plans.

9. The system of claim 7, wherein the processor is further caused to:
receive data comprising health facility information selected by the consumer;
wherein the result information further comprises information describing whether health facilities associated with the health facility information selected by the consumer are included within the network of each of the health insurance plans.
